(19) United States
(12) Patent Application Publication
(10) Pub. No.: US 2005/0089357 A1
(43) Pub. Date: Apr. 28, 2005

(54) Printing module for mounting in shop scales

(75) Inventor: Walter Holike, Geislingen (DE)

Correspondence Address: Friedrich Kueffner, Suite 910, 317 Madison Avenue, New York, NY, 10017, US

(73) Assignee: Mettler-Toledo (Albstadt) GmbH, Albstadt (DE)

(21) Appl. No.: 10/505,206

(22) PCT Filed: Feb. 20, 2003
(86) PCT No.: PCT/EP03/01736

(30) Foreign Application Priority Data
Feb. 21, 2002 (DE) 102 07 332.5

(51) Int. Cl. B41J 11/26

(52) U.S. Cl. 400/613

(57) ABSTRACT

The invention relates to a printing module for mounting in shop scales. Said printing module comprises a base plate (1) having mounting areas for two printing groups (6, 6′) and two print roll unwinding bearings (4, 17). Said printing module can be used to simultaneously operate the scales in an operating mode in which goods sold are logged on a paper strip, and in a display mode in which goods display labels are printed on a label strip.

The invention pertains to a printer module for mounting in a shop scale with a base plate, which has a first mounting area for a first unwinding bearing to hold a first supply roll of a strip-like medium to be printed and a second mounting area for a first printing mechanism, which comprises a transport roll equipped with a rotary drive and a print head opposite the transport roll.

It is known that shop scales that print can operate in two different ways, which are called in the following the “customer service mode” and the “labeling mode”. In the former or customer service mode, a sales person places the merchandise being purchased by the customer on the scale, and a record of the sales process is printed out, this record including, for example, the weight of the merchandise, its price, and the type of item purchased. In this case, the strip-like medium to be printed consists of an endless strip of paper, on which the information is printed in text mode in a predetermined type font. After the information has been printed, the printed section of the strip, the length of which will change depending on the number of items purchased, is torn off from the endless strip and handed to the customer. In the second or labeling mode, the scale is used to print out self-adhesive labels, which are placed on the merchandise such as fruit and vegetables in particular to identify them. In this case, the printing operation is carried out in graphics mode in the form of individual pixels based on a predetermined bitmap. The strip-shaped medium to be printed in this case is either a strip of labels carried on a backing strip, from which the labels are peeled off after they have been printed, or a continuous strip of labels without a backing strip, the individual labels being separated from the strip at predetermined separation points after the printing process.

So that the same shop scale can be used both in customer service mode and in labeling mode, the conventional approach is to provide two separate printers, one of which is put into operation for customer service mode, in which case the supply roll is an endless strip of rolled-up paper, whereas the other printer is operated in graphics mode, in which case the supply roll is a roll of labels.

In contrast to scales which are used only in customer service mode or only in labeling mode, it is therefore conventional for scales which are intended for use in both modes to have a housing with a mounting space which is large enough to accept the two separate printers. It is therefore unavoidable that the housings will be designed in different ways, and thus the scales will have different external appearances. In addition, the work of producing and mounting the two separate printers is complicated.

The invention is based on the task of creating a printer module of the type indicated above which is adapted in an especially efficient manner to the different operating requirements of shop scales.

This task is accomplished according to the invention in that the base plate has a mounting area for a second unwinding bearing to accept a second supply roll of a strip-like medium to be printed and a mounting area for a second printer, which comprises a transport roll equipped with a rotary drive and a print head opposite the transport roll.

In the printer module according to the invention, therefore, mounting areas for two printers and for two unwinding bearings are provided on a single base plate. In cases where the shop scale will be used in only one operating mode, only a single printing mechanism and only a single unwinding bearing can be mounted on the base plate. If the shop scale is to be equipped for both customer service mode and labeling mode, both printer mounting areas will be equipped with printing mechanisms, and both bearing mounting sites will be provided with unwinding bearings. The first supply roll formed by the endless paper strip will be installed on the first unwinding bearing. The endless paper strip is guided from the first supply roll to the first printing mechanism and is then conducted between the transport roll and the print head, where it is thus printed in text mode as the transport roll carries it through. The roll of labels required for labeling mode serves as the second supply roll and is thus placed on the second unwinding bearing. From there, the strip of labels is sent to the second printing mechanism and is conducted between the print head and the transport roll. In this way, the labels can be printed in graphics mode as they pass through between the transport roll and the opposing print head.

Even if the shop scale is designed for only a single mode, it can be very effective to equip both mounting areas with printing mechanisms. If a problem should occur in one of the printing mechanisms, the strip-like medium can be removed from the malfunctioning printing mechanism and inserted into the other printing mechanism. Operation can thus be resumed in a very short time.

With respect to the ability to use labels which are carried on a backing strip, it is effective in another embodiment of the invention for the base plate to have a mounting area in which a take-up spool with a rotary drive can be installed. After the backing strip carrying the labels has passed through the associated printing mechanism, it is deflected sharply in the known manner and directed toward the take-up spool, on which it is rolled up. At the point of the sharp deflection, the intrinsic stiffness of the printed labels causes the labels to separate from the backing strip, and they can then be easily removed and applied to the merchandise.

In an effective embodiment, it is provided that each rotary drive comprises an electric motor with a takeoff shaft perpendicular to the base plate and a gear assembly, the drive wheel of which meshes with a pinion seated on the takeoff shaft of the electric motor, whereas the takeoff wheel is connected nonrotatably to the drive shaft of the transport roll or of the take-up spool, which is perpendicular to the base plate. As a result, it is possible, first, to obtain the required speed reductions between the rpm's of the electric motors and the required rpm's of the drive shafts and, second, to adjust the spatial distances between the electric motors and the transport rolls or the take-up spool driven by them in a manner which is optimal for the most efficient utilization of the space available on the base plate.

In this connection, an especially advantageous embodiment consists in that the electric motors, the unwinding bearings, the printing mechanisms, and the take-up spool are mounted on one side of the base plate, whereas the gear assemblies are mounted on the other side of the base plate. With this design, therefore, the side of the base plate on which the strip-like media pass between their associated unwinding bearings and the printing mechanisms are kept out of the way of the gear assemblies, with the result that the latter cannot obstruct the routes along which the strip-like media must travel.

It is also provided within the scope of the invention that a single electronic control circuit is provided for both printing mechanisms. The print heads will usually be bar-like thermal print heads, which extend transversely to the travel direction of the strip-like media and are therefore perpendicular to the base plate. In this direction, the thermal print heads have a number of individually actuatable thermal elements, each of which produces a single pixel when actuated. A single microprocessor is sufficient for the common electronic control circuit. The electronic control circuit coordinates the transport movement of the transport rolls with the actuation of the thermal elements of the thermal print head in the known manner so that the thermal print head prints the desired content on the surface of the strip-like medium to be printed as the medium passes through between the thermal print head and the transport roll.

For the sake of efficient space utilization, it is also advantageous in this connection for the electronic control circuit to be mounted on a board parallel to the base plate.

The invention is explained in greater detail in the following description with reference to the drawings:

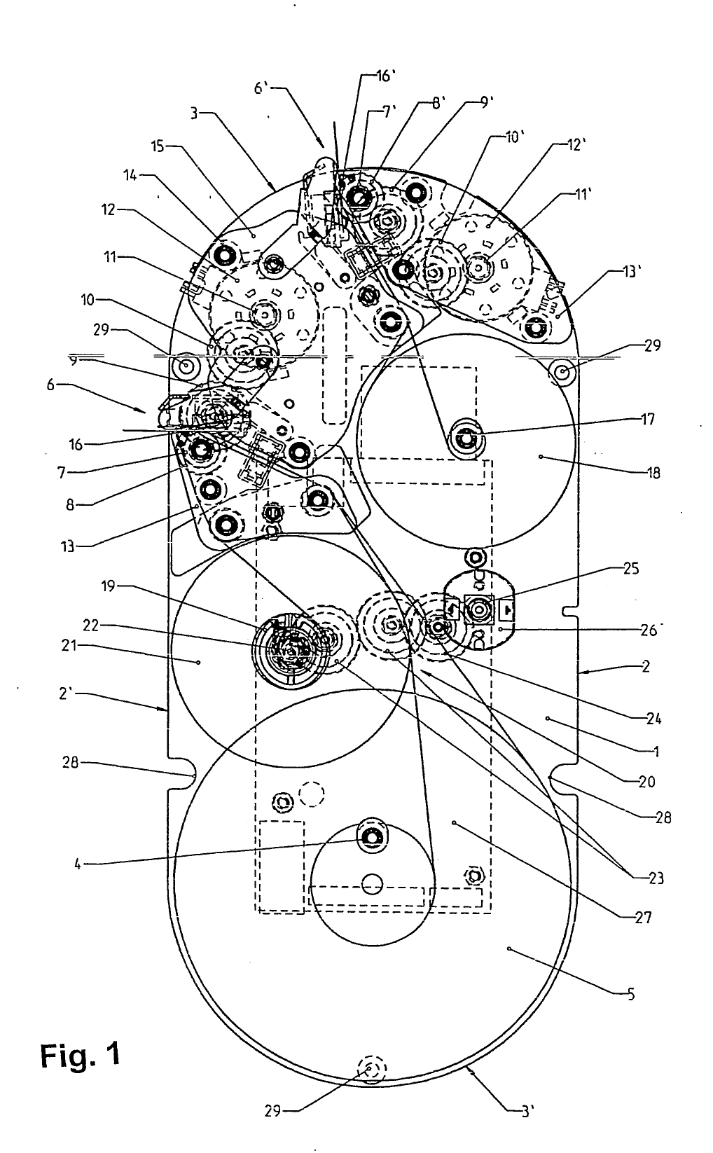

FIG. 1 shows a view of an exposed printer module, without its housing; and

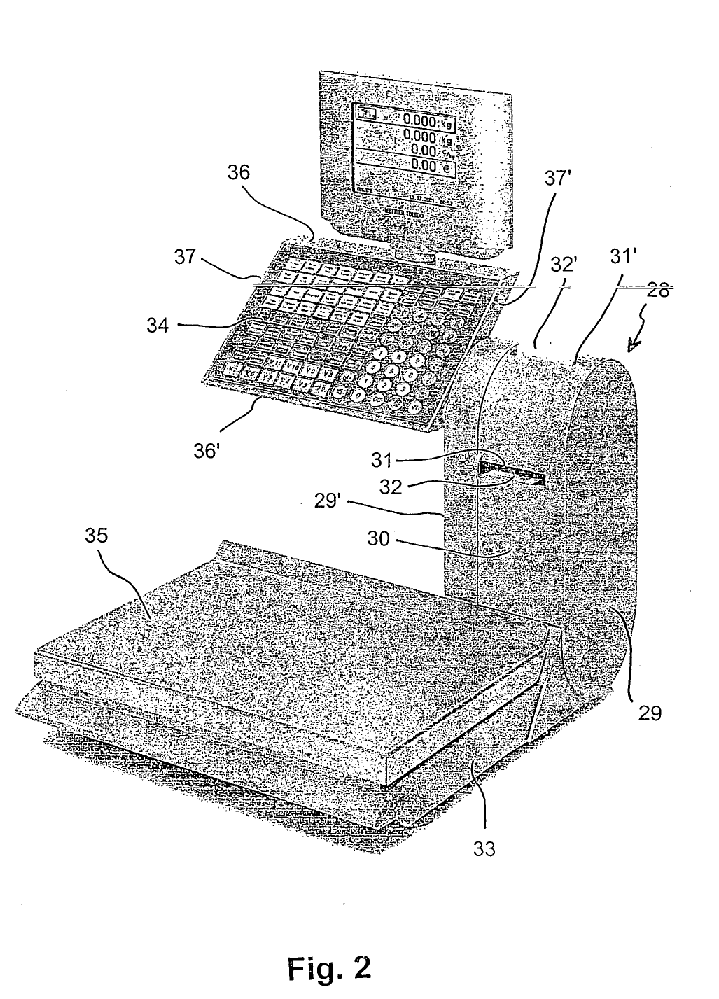

FIG. 2 shows a perspective view of a shop scale in which the printer module illustrated in FIG. 1 has been installed.

FIG. 1 shows a view perpendicular to the plane of the drawing, in which the base plate 1 of a printer module lies. The base plate 1 is bounded by two opposing, parallel edge sections 2, 2′, which are connected to each other at the ends shown on the left and right in the drawing by semicircular edge sections 3, 3′.

Near the area of the base plate bounded by the circular edge section 3′ on the right, a mounting area is provided between the two edge sections 2, 2′ on the center line of the base plate 1. A first unwinding bearing 4 is mounted here. The bearing is designed in the form of a stud bolt, attached to the base plate 1; in the figure, this bolt is perpendicular to the base plate 1 and extends toward the observer. A first supply roll 5 is laid loosely on this unwinding bearing 4, the unwinding bearing 4 passing through a central opening in the supply roll 5. The supply roll 5 is, for example, a rolled-up strip of labels, the adhesive labels of which are carried on a backing strip.

In the area of the base plate 1 bounded by the circular edge section 3 on the left, mounting areas are provided for a first printing mechanism 6 and a second printing mechanism 6′. Each of these printing mechanisms has its own transport roll 7, 7′ on the side of the base plate 1 facing the observer; the axial drive shafts of these rolls are perpendicular to the base plate 1, and one end of each shaft passes through the base plate to the other side. A takeoff gear wheel 8, 8′ of a gear assembly is seated nonrotatably on the end of each drive shaft which passes through the pressure plate 1; the gear train also includes an intermediate gear wheel 9, 9′ and a drive gear wheel 10, 10′ meshing with the intermediate wheel. Each drive wheel 10, 10′ meshes with a pinion 11, 11′, which is seated nonrotatably on the takeoff shaft, extending through the base plate 1, of an electric motor 12, 12′, which is mounted on the side of the base plate 1 facing the observer. The ends of the drive shafts of the transport rolls 7, 7′ pointing toward the observer are supported in mounting plates 13, 13′, which are separated from the base plate 1 by a distance equal to the width of the transport roll. These mounting plates 13, 13′ are attached to the base plate 1 by spacer bolts 14, which are perpendicular to the base plate.

Between the mounting plates 13, 13′, a mounting plate 15 is provided at the same distance above the base plate 1 as the other mounting plates. Like the mounting plates 13, 13′, this mounting plate is parallel to the base plate 1 and is supported on it by spacer bolts 14, which are perpendicular to the base plate. Between the mounting plate 15 and the base plate 1, the thermal print heads 16, 16′ are mounted in the areas facing the transport rolls 7, 7′; the print heads are in the form of bars which extend perpendicular to the base plate 1 and are held in contact with their associated transport rolls 7, 7′.

A mounting area for a second unwinding bearing 17 is provided on the base plate a certain distance away from the area of the base plate 1 located underneath the mounting plates 13, 13′, 15. The unwinding bearing 17 is designed in the form of a stud bolt attached to the base plate 1 and points away from the base plate toward the observer. A second supply roll 18 is loaded loosely on this second unwinding bearing 17, the bolt passing through a central opening in the second supply roll 18. The second supply roll 18 consists, for example, of an endless strip of rolled-up paper.

A mounting site for a take-up spool 19 and its rotary drive 20 is provided in the area of the pressure plate 1 located between the first printing mechanism 6 and the first unwinding bearing 4. The take-up spool 19 has a drive shaft 22, perpendicular to the base plate 1, one end of which extends through the base plate 1 to the other side. A takeoff gear wheel of a gear assembly is mounted on the end of the shaft which passes through the base plate 1. This takeoff wheel is connected in via intermediate gear wheels 23, also supported on the side of the base plate 1 facing away from the observer, to a drive wheel 24, which meshes with the pinion 25 of an electric motor 26, mounted on the side of the base plate 1 facing the observer, this pinion being seated on the motor's takeoff shaft, which passes through the base plate 1 to the other side.

In the exemplary embodiment shown here, in which the corresponding mounting plates are fully equipped with the unwinding bearings 4, 17, the printing mechanisms 6, 6′, and the take-up spool 19, the endless paper strip can be guided, for example, from the second supply roll 18 to the second printing mechanism 6′, where it is printed in customer service mode as it passes through between the transport roll 7′ and the thermal print head 16′. FIG. 1 shows the routes which the endless paper strip will travel from the second supply roll 18 to the second printing mechanism 6′ in the two possible limit cases, namely, the case in which the supply roll 18 is completely empty and the case in which it is completely full, the diameter of the supply roll therefore being at its smallest in the former case and at its largest in the latter. As the supply roll 18 is used up, the actual transport route will always be somewhere between the two limit cases shown in the drawing. In addition, the label strip can be guided from the first supply roll 5 to the first printing mechanism 6, where it is printed in labeling mode as it passes through between the thermal print head 16 and the transport roll 7. Here, too, FIG. 1 shows the transport routes along which the label strip will travel in the two limit cases, i.e., that in which the first supply roll 5 is full and therefore has its largest diameter and that in which it is empty and therefore has its smallest diameter. The actual transport route in all other operating states will again be somewhere between the two limit cases shown in the drawing. After the backing strip has passed through the first printing mechanism 6, it is sharply deflected and thus freed of its labels; it is then is sent onward to the take-up spool 19, where it is rolled up to form the backing strip roll 21. The maximum circumferences of the first supply roll 5 and of the backing strip roll 21 are drawn in the figure. These maximum circumferences intersect. In fact, however, the radius of the backing strip roll 21, which is always increasing as the roll is being rolled up, and the radius of the first supply roll 5, which is always decreasing as the roll is being unrolled, will always be in areas which exclude the possibility of mutual interference between the two rolls.

Because of the spatial relationships present in the exemplary embodiment illustrated here, the strip-like medium being taken from the first supply roll can be processed alternatively by the first printing mechanism 6. Through the arrangement of suitable strip guides (not shown), it is also possible to deflect the strip-like medium from the first supply roll 5 to the second printing mechanism 6′ and to process it there. When the base plate 1 is minimally equipped with only the first or with only the second unwinding bearing 4 or 17 and with only one of the printing mechanisms 6, 6′, the assembly can be used as a pure paper strip printer for customer service mode. If the base plate 1 is also equipped with the take-up spool 19, it can be used as a label printer.

On the side of the base plate 1 facing away from the observer, a rectangular circuit board 27 extending parallel to the base plate 1 is attached to the base plate by way of spacers; this board carries the control electronic devices for the printing mechanisms 6, 6′ and also for the rotary drive 20 of the take-up spool 19. These control electronic devices control the excitation of the thermal elements of the thermal print heads 16, 16′ and all of the rotary drives in such a way that the desired printing is produced on the strip-like media.

It can also be seen in the drawing that mounting and positioning openings and attachment holes are formed in the base plate 1, some of which are designated by the reference numbers 28 and 29. These elements allow the assembly to be installed in the standardized mounting space in the scale housing.

FIG. 2 shows the printer module according to FIG. 1 surrounded by a housing 28, which has two parallel, flat end surfaces 29, 29′ corresponding to the shape of the base plate 1, which end surfaces are separated from each other by a distance which is large enough to accommodate the dimension of the assembly shown in FIG. 1 in the direction perpendicular to the base plate 1. In the lateral surface 30 of the housing 28 connecting the edges of the two end surfaces 29, 29′ to each other, outlet slots 31, 31′ are provided for the strip-like media 32, 32′ which have been printed by the associated printing mechanisms, these slots being located opposite the mounting areas inside the housing 28 for the first and second printing mechanisms 6, 6′.

The housing 28 is mounted on the substructure 33 of the shop scale with an orientation such that the side edges which are parallel to the edge sections 2, 2′ of the base plate 1 extend vertically. The bottom area of the housing 28 which is in contact with the substructure 33 consists approximately of the curved-part of the lateral surface 30 facing the observer in FIG. 2, its curvature conforming to the curved edge section 3′ of the base plate 1 shown in FIG. 1. From there, the area of the housing 28 conforming to the straight edge sections 3, 3′ of the base plate 1 extends freely upward to the curved part of the housing conforming to the curvature of the edge section 3 on the left in FIG. 1. There, an input keyboard 34 is mounted on the end surface 29′ in such a way that it projects freely outward from the end surface 29′ and thus is situated a certain vertical distance above a weighing platform 35, which is supported on the substructure 33. The input keyboard 34 is designed essentially in the form of a flat rectangle with two parallel side edges 36, 36′, which are themselves parallel to the plane of the weighing platform 35, and with two side edges 37, 37′, which are perpendicular to the first set of edges and which form a certain angle to the plane of the weighting platform 35. The angle of inclination is selected so that the lower side edge 36′ of the input keyboard 34 is closer to the user than the upper side edge 36.

A visual display field 38, on which the weighing data are displayed, is supported vertically on the upper side edge 36 of the input keyboard 34.

As a result of this arrangement, the shop scale provided with the printer module and its housing 28 has not only an especially attractive appearance but also an advantageous ergonomic design with respect to operation. The input keyboard 34 can be conveniently operated after the merchandise has been placed on the weighting platform 35. The weighing data can be easily read on the visual display 38. The printed sections of the strip-like media dispensed by the printer module through the outlet openings 31, 31′ can be conveniently removed.

### List of Reference Numbers

1 base plate
2, 2′ edge sections
3, 3′ edge sections
4 first unwinding bearing
5 first supply roll
6 first printing mechanism
6′ second printing mechanism
7, 7′ transport rolls
8, 8′ takeoff gear wheels
9, 9′ intermediate gear wheels
10, 10′ drive gear wheel
11, 11′ pinion
12, 12′ electric motor
13, 13′ mounting plate
14 spacer bolt
15 mounting plate
16, 16′ thermal print head
17 second unwinding bearing
18 second supply roll
19 take-up spool
20 rotary drive
21 backing strip roll
22 drive shaft
23 intermediate gear wheels
24 drive gear wheel
25 pinion
26 electric motor
27 circuit board
28 housing
29, 29′ end surface
30 lateral surface
31, 31′ outlet slots
32, 32′ strip-like medium
33 substructure
34 input keyboard
35 weighing platform
36, 36′ side edges
37, 37′ side edges
38 visual display

1. Printer module for mounting in a shop scale, with a base plate (1), which has:
a mounting area for a first unwinding bearing (4), which holds a first supply roll (5) of a strip-like medium to be printed, and
a mounting area for a first printing mechanism (6), which comprises a transport roll (7) with a rotary drive and a print head (16) opposite the transport roll (7),
wherein the base plate (1) has
a mounting area for a second unwinding bearing (17), which holds a second supply roll (18) of a strip-like medium to be printed, and
a mounting area for a second printing mechanism (6′), which comprises a transport roll (7′) with a rotary drive and a print head (16′) opposite the transport roll (7′).

2. Printer module according to claim 1, wherein the base plate (1) has a mounting area for a take-up spool (19) with a rotary drive.

3. Printer module according to claim 1, wherein at least one of the two unwinding bearings (4, 17) is in a position from which the strip-like medium can be guided optionally either to the first printing mechanism (6) or to the second printing mechanism (6′).

4. Printer module according to claim 1, wherein each rotary drive has an electric motor (12, 12′, 26) with a takeoff shaft perpendicular to the base plate (1) and a gear assembly, the drive wheel (10, 10′, 24) of which meshes with a pinion (11, 11′ 25) seated on the takeoff shaft of the electric motor (12, 12′, 26), whereas its takeoff wheel (8, 8′) is connected nonrotatably to the drive shaft of the transport roll (7, 7′) or of the take-up spool (19), the drive shaft being perpendicular to the base plate (1).

5. Printer module according to claim 4, wherein the electric motors (12, 12′, 26), the unwinding bearings (4, 17), the printing mechanisms (6, 6′), and the take-up spool (19) are arranged on one side of the base plate (1), whereas the gear assemblies are arranged on the other side of the base plate (1).

6. Printer module according to claim 1, wherein common electronics are provided for both printing mechanisms (6, 6′).

7. Printer module according to claim 6, wherein the control electronics are provided on a circuit board (27) extending parallel to the base plate (1).

8. Printer module according to claim 1, comprising a housing (28) enclosing the assembly, in which housing an outlet slot (31, 31′) is provided for each printing mechanism to allow the strip-like medium (32, 32′) printed by the associated printing mechanism to exit.

9. Printer module according to claim 8, wherein the housing (28) is mounted on the substructure (33) of the shop scale serving to support the weighing platform (35).

10. Printer module according to claim 9, wherein an input keyboard (34) is mounted on the housing (38) a certain distance away from the weighing platform (35).

11. Printer module according to claim 10, wherein the two outlet slots (31, 31′) are located in areas of the housing (28) close to the input keyboard (34).

12. Printer module according to claim 10, wherein a visual display device (38) is mounted on the input keyboard (34).
